(19) United States
(12) Patent Application Publication
(10) Pub. No.: US 2014/0108542 A1
(43) Pub. Date: Apr. 17, 2014

(54) Method and system for providing a multiuser web session

(71) Applicant: NEC Europe Ltd., Heidelberg (DE)

(72) Inventors: Bin CHENG, Eppelheim (DE); Jorn FRANKE, Heidelberg (DE)

(21) Appl. No.: 14/050,726

(22) Filed: Oct. 10, 2013

(30) Foreign Application Priority Data
Oct. 11, 2012 (EP) 12188205.4

(51) Int. Cl. H04L 29/06

(52) U.S. Cl. CPC H04L 65/403
USPC 709/204

(57) ABSTRACT

A method for providing a multiuser web session, preferably a collaborative web browsing session like a cobrowsing session, includes the steps of
a) establishing a multiuser web session with different participants,
b) providing the multiuser web session via a session server to different participants,
c) relaying requests from the participants to one or more web servers and responses from the one or more web servers to the participants,
   wherein a participant of the multiuser web session creates the multiuser web session, establishes a connection, preferably a secure connection, with the one or more web servers and relays the outside multiuser web communication between all the participants of the multiuser web session and the one or more web servers, wherein private data is masked. The present invention further relates to a system for providing a multiuser web session.

### FIELD OF THE INVENTION

The present invention relates to a method for providing a multiuser web session, preferably a collaborative web browsing session like a cobrowsing session.

The present invention further relates to a system for providing a multiuser web session, preferably a collaborative web browsing session like a cobrowsing session and preferably for performing with a method according to one of the claims 1-14 comprising one or more web servers for providing a content, a session server for relaying communication between participants of the multiuser web session and the web server, and user participating means for participating in the multiuser web session by a user.

Although applicable in general to any kind of multiuser web session the present invention will be described with regard to a cobrowsing session.

### BACKGROUND OF THE INVENTION

Collaborative web browsing, for example cobrowsing has become a popular subject in recent years. Within a collaborative web browsing session different participants in the same session have for example the same view and share user interactions in nearly real time under the same browsed website. One of the use cases is for example that an insurance clerk can help a customer to fill out a form on a webpage through cobrowsing. In this case the clerk should be able to see the customer's view on the website and vice versa. For accessing such a cobrowsing service a standard browser without any plugins or extensions is needed.

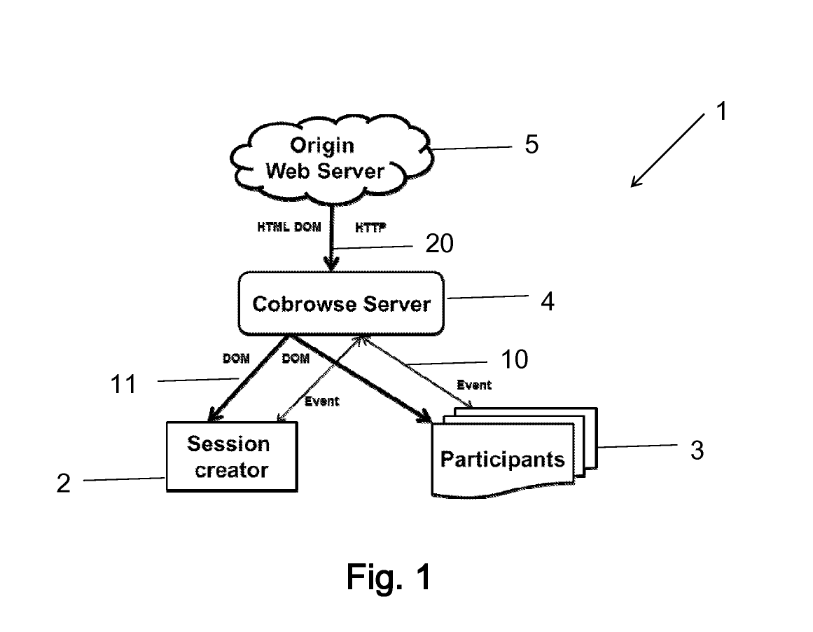

In FIG. 1 a conventional system for cobrowsing is shown. A cobrowse server 4 acts as a web proxy running in between an origin web server 5 and all participants 3 in a same cobrowsing session. For instance the cobrowse server 4 first fetches a page content from the origin web server 5 and then injects a piece of JavaScript code into the page for enabling a cobrowsing service before forwarding the modified webpage to all participants 3. Further the cobrowser server 4 coordinates data traffic via the document object model 11 and for exchanging events 10 between the participants 3. To initiate a conventional cobrowsing session a session creator 2, being also a participant of the created cobrowsing session initiates such a session and interacts with the cobrowse server 4 for providing the created cobrowsing session to the other participants 3.

For example in US 2008/0276183 A1 and US 2010/0306642 A1 such conventional cobrowsing systems are described.

One of the major drawbacks of conventional cobrowsing systems and methods is, that privacy cannot be ensured between participants: The cobrowse server 4 has first access of a cobrowsed webpage and is able to see any entry or data in that page. HTTPS-based web services can also be not supported by conventional systems because HTTPS-based secure connections do not allow any third party to change the content in between the origin web server 5 and the participants 3.

Although U.S. Pat. No. 7,305,439 B2 addresses this problem the method described therein simply stops the cobrowsing session when an encrypted session with private data is entered, for example a link is clicked by one of the users or the like.

However, this limits the use of this method in many cases: for example a customer service agent cannot help the client anymore when private data is entered.

### SUMMARY OF THE INVENTION

It is therefore an objective of the present invention to provide a method and a system for providing a multiuser web session ensuring privacy of participants in the multiuser web session.

It is a further objective of the present invention to provide a method and a system for providing a multiuser web session supporting secure connections and secure services like HTTPS-based web services.

It is a further objective of the present invention to provide a method and a system for providing a multiuser web session being more flexible in terms of applications and/or use cases as well as in defining private data.

It is an even further objective of the present invention to provide a method and a system for providing a multiuser web session, which can be easily implemented, in particular without plugins or extensions.

The aforementioned objectives are accomplished by a method of claim 1 and a system of claim 15.

In claim 1 a method for providing a multiuser web session, preferably a collaborative web browsing session like a cobrowsing session is defined, comprising the steps of
a) Establishing a multiuser web session with different participants,
b) Providing the multiuser web session via a session server to the different participants,
c) Relaying requests from the participants to one or more web servers and responses from the one or more web servers to the participants.

According to claim 1 the method is characterized in that a participant of the multiuser web session creates the multiuser web session, establishes a connection, preferably a secure connection, with the one or more web servers and relays the outside multiuser web communication between all the participants of the multiuser web session and the one or more web servers, wherein private data is masked.

The aforementioned objectives are also accomplished by a system of claim 15.

In claim 15 a system for providing a multiuser web session is defined, preferably a collaborative web browsing session like a cobrowsing session, and preferably by performing with a method according to one of the claims 1-14, comprising one or more web servers for providing content, a session server for relaying communication between participants of the multiuser web session, and user participating means for participating in the multiuser web session by users.

According to claim 15 the system is characterized in, that at least one of the user participating means is operable to create the multiuser web session, to establish a connection, preferably a secure connection, with the one or more web servers, to relay the outside multiuser web communication between all the participants of the multiuser web session and the one or more web servers, and to mask private data.

The term “multiuser web session” is to be understood in the most general sense: A multiuser web session may be any session in which two or more users interact with each other, e.g. viewing a web page together or the like.

The term “web server” is to be understood in the most general sense. For instance it can be a content provider delivering services to a plurality of participants via the internet. The web server may also provide multisession support script enabling a session creator to initiate a multiuser web session.

The term “session server” is to be understood in the most general sense. In particular the session server enables the session creator to collaboratively browse a webpage with other participants.

According to the invention it has been recognized, that by establishing a direct connection from a session creator to the origin web server and by masking private data cobrowsing for HTTPS-based web services is enabled.

According to the invention it has been further recognized, that private data with third parties is not shared: The cobrowse server cannot see sensitive information marked as private data.

According to the invention it has been further recognized that no plugins or extensions like browser plugins are required to support cobrowsing; thus an easy implementation is enabled.

According to the invention it has been further recognized that flexibility is enhanced, since for example both the origin web server and the session creator are able to mask private elements e.g. within a requested webpage or the like.

In other words a privacy preserving cobrowsing method and a corresponding system is provided enabling a masking of private data for other participants while still enabling collaborative web sessions like web browsing sessions. Both HTTP-based web services as well as HTTPS-based secure web services may be used for the multiuser web session.

Further features, advantages and preferred embodiments are described in the following subclaims.

According to a preferred embodiment the participant creating the multiuser web session masks private data. This enables the session creator to keep full control over private data, e.g. the session creator can decide which part of a content to share with other participants.

According to a further preferred embodiment the one or more web servers mark elements indicating private data in the responses. This enables in an easy way for the session creator to mask private data based on the marked elements of the one or more web servers. One of the further advantages is, when more or more web servers mark elements for private data the session creator does not need to mark private data by its own. For example before the session creator fetches a web pages for starting a cobrowsing session the one ore more web servers can mark the webpage to specify which part of the webpage is supposed to be sensitive for their customers. This part of content may then be automatically regarded as private element when a user established a cobrowsing session for the webpage. Preferably, to mark elements by the one or more web servers an external file associated with the requested data may be created by an application provider to define private elements in the corresponding data, preferably through a declarative script language which can then be interpreted by the session creator.

According to a further preferred embodiment private data is marked visually. A session creator as well as the other participants can then easily identify and recognize elements with masked private data. This also improves a user experience since for example the session creator marked private data, for example before the webpage is transmitted to the other participants. The session creator can visually see which part of elements are already marked and can also continue to visually mark other elements.

According to a further preferred embodiment a marking policy is generated for automatically masking private data. This enables more flexibility. For example instead of marking certain areas of a HTML-document as private a global policy can be defined as part of the HTML-document and can be used so that form data is not propagated or text is not shown in tables. A HTML query language for defining what to be replaced, for example jQuery, can be used for providing a policy.

According to a further preferred embodiment prior to provide data including masked private data to the other participants a preview of the data is performed, preferably by the participant who created the multiuser web session. This enables e.g. the first user/session creator to review the data for the other participants with the masked private data, i.e. to have a test mode. The session creator can then see what information the other participants will actually see to make sure the private data has been properly masked. For example upon a click on a button or a special key on a keyboard or any other input means a user can switch between a masked and a non-masked version of a webpage.

According to further preferred embodiment the marking policy is stored for later use. This enables to reuse rules and/or specifications of which elements will be masked or stored, for example in form of a template, so that the template can be provided to the other participants for reusing some or all pre-defined masking rules of the marking policy, when one of the other participants would like to create a later multiuser web session of its own.

According to a further preferred embodiment for each participant individual marking of a private data is performed. This enables that each participant in the multiuser web session can see his or her individual view on private data. For different participants different parts for example of a HTML-document may be marked as private data depending on a security level assigned to each participant.

According to a further preferred embodiment masking of private data is performed by replacing the private data with pre-defined non-sensible data. This enables in an easy way to hide private data.

According to a preferred embodiment the pre-defined non-sensible data, preferably in form of random data, is based on the type and/or element type of the private data. This enables to adapt non-sensible data with which the private data is marked with data based on the type and/or element type of the private data, so that all participants know that a certain type of data is masked. For example a bank account number may be replaced with the text “bank account number”. A further example is, that for example an input password is replaced with the term “PWD” or “password” or the like.

According to a further preferred embodiment a secure connection is used between the participants and/or between the participant creating the multiuser web session and the one or more web servers. This enables an end-to-end data encryption to prevent eavesdropping of other parties.

According to a further preferred embodiment the secure connection is provided in form of a HTTPS connection or a public key/private key encrypted connection. Whereas a HTTPS-based connection can be easily be used, since in all modern browsers for example is supported, a public key/private key encryption, preferably together with an external third party acting as a certification authority ensuring that each participant is the one he/she pretends to be, only a corresponding participant can be en-/decrypt the exchanged data. For example in this way a cobrowse service or server cannot see any web application data.

According to a further preferred embodiment events on masked private data are coordinated, preferably via the session server, to synchronize actions of participants on private data among the other participants. This enables that the session creator and the other participants are able to share the activity for example on a webpage without disclosing the private data to other participants. For instance if the session server coordinates the events the session server has to work on slightly different webpages, in particular the propagation of the update events associated with the private data of those marked private elements has to be avoided.

According to a further preferred embodiment multiuser web session information ensuring privacy of a private data is provided by the one or more web servers applied in the multiuser web session, preferably by executing the multiuser web session information by the participant creating the multiuser web session. For example multiuser web session information may include cobrowsing support scripts provided for the session creator to be executed to implement multiuser web session functionality for privacy preserving. These scripts may contain a proxy delivering for example webpages and other data from the one or more web servers to a session server so that other participants can join the created multiuser web session. These scripts may mask private data so that the session creator does not send out the private data to the session server and thus to the participants in the multiuser web session.

There are several ways how to design and further develop the teaching of the present invention in an advantageous way. To this end it is to be referred to the patent claims subordinate to patent claim 1 on the one hand and to the following explanation of preferred embodiments of the invention by way of example, illustrated by the figure on the other hand. In connection with the explanation of the preferred embodiments of the invention by the aid of the figure, generally preferred embodiments and further developments of the teaching will be explained.

### BRIEF DESCRIPTION OF THE DESCRIPTION

In the drawings

FIG. 1 shows a conventional system for cobrowsing;

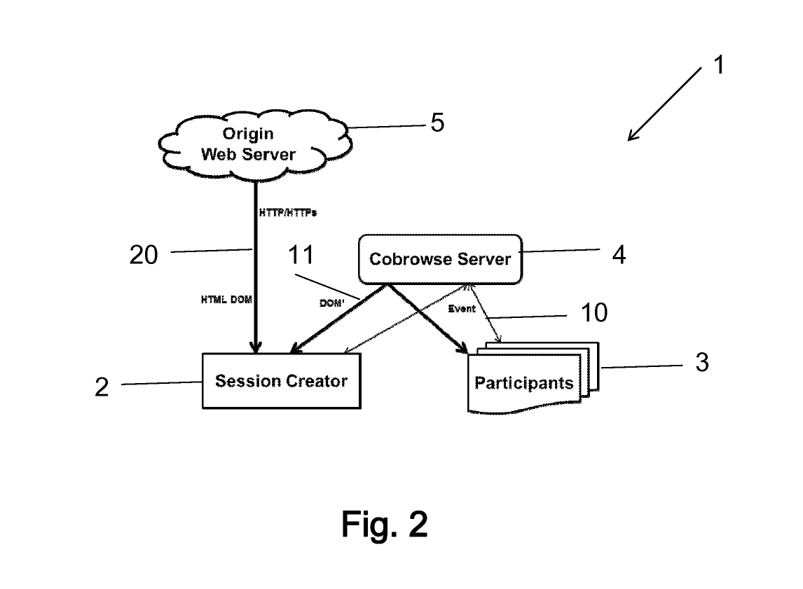

FIG. 2 shows a system according to a first embodiment of the present invention; and

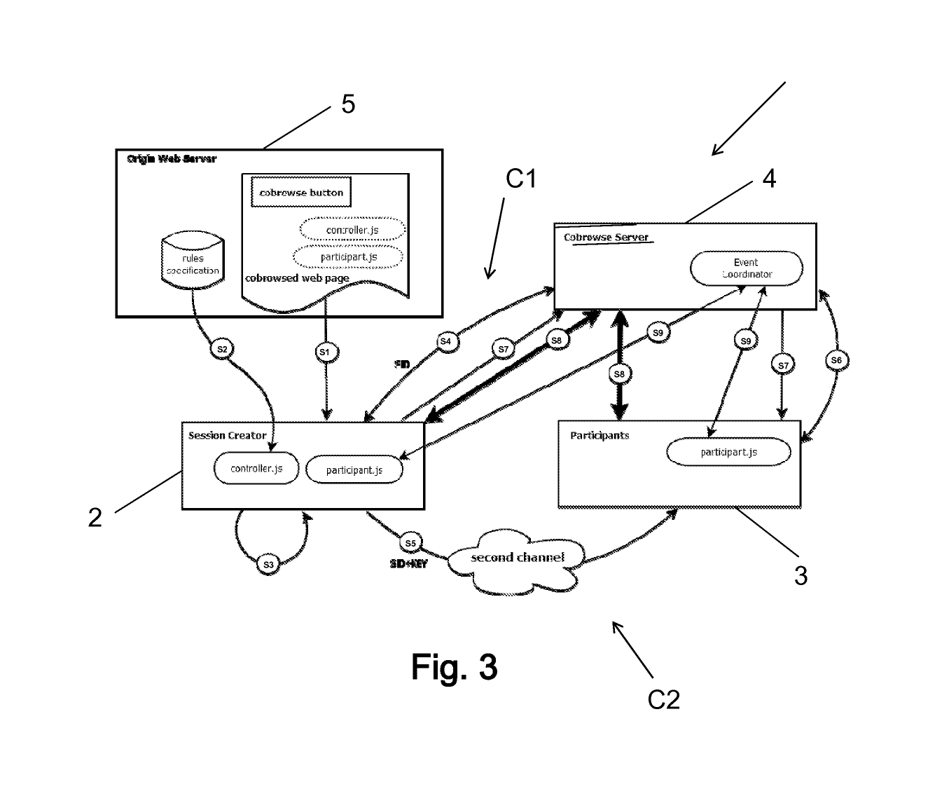

FIG. 3 shows a part of a method and a system according to a second embodiment of the present invention.

### DETAILED DESCRIPTION OF THE INVENTION

FIG. 1 shows a conventional system for cobrowsing.

In FIG. 1 a conventional web-based cobrowsing system is shown. A cobrowse server 4 acts as a web proxy running in between an origin web server 5 and all the participants 3 in the same cobrowsing session. For instance, the cobrowse server 4 first fetches a page content from the origin web server 5 and for example injects a piece of JavaScript code into the page for enabling a cobrowsing service before forwarding the modified webpage to all participants 3. Further the cobrowser server 4 coordinates data traffic via the document object model 11 and for exchanging events 10 between the participants 3. To initiate a conventional cobrowsing session a session creator 2, being a participant of the created cobrowsing session initiates such a session and interacts with the cobrowse server 4 for providing the created cobrowsing session to the other participants 3.

FIG. 2 shows a system according to a first embodiment of the present invention.

In FIG. 2 an architecture of a privacy preserving cobrowsing service according to an embodiment of the invention is shown. In contrast to the system of FIG. 1 the origin web server 5 is directly connected (reference sign 20) to the session creator 2. The session creator 2 is connected (reference signs 10 and 11) via the document object model interface respectively for event coordination and via the cobrowse server 4 with the other participants 3.

In general the origin web server 5 may be a standard web server delivering a web application. For instance the origin web server 5 may be a content provider or an insurance company delivering services to their customers via the internet. The origin web server 5 may be independent of the cobrowse server 4. To enable a privacy preserving cobrowsing service the origin web server 5 may put an indication, like a “cobrowse” button into provided webpages, so that the privacy preserving cobrowsing service can be triggered when a session creator 2 clicks the “cobrowse” button for initiating such a service. Further, the origin web server 5 may provide cobrowsing support scripts implementing one or more parts of the cobrowsing functionality to preserve privacy.

The session creator 2 may in particular be a browser client rendering a web page provided by the origin web server 5. The session creator 2 may operated by a user creating a cobrowsing session. Furthermore the session creator 2 may provide or execute scripts which may be provided by the origin web server 5 implementing parts of the cobrowse functionality to preserve privacy. These scripts may contain a proxy delivering requested webpages and other data from the origin web server 5 to the cobrowse server 4, so that the other participants 3 in the same cobrowsing session can join the session. These scripts can mask private data, so that the session creator 2 does not send out the private data to the cobrowse server 4 and the other participants 3. Further different private policies may be applied by the script(s) or a session creator 2 may decide what data should be transferred via the cobrowse server 4 to the other participants 3. Events related to private data in an application are not sent to the cobrowse server 4 and the other participants. Such events may for example be an entry of a new bank account number or the like.

The cobrowse server 4 provides the functionality to collaboratively browse for example a webpage provided by the session creator 2. The cobrowse server 4 in particular is operable to
forward a masked webpage from the session creator 2 to the other participants 3,
act as a proxy for the other participants 3 to fetch the content of for example embedded static objects in the cobrowsed webpage from the session creator 2 on requests and
synchronize events occurring on the masked and shared page with other participants 3, so that users in the same cobrowsing session can still share their interactions, for example mouse moves, scrolls, clicks or the like.

The participants 3 participate in the cobrowsing session, for example via their browser clients. They can see only a version of a webpage comprising no private data, because the private data has been already masked by the session creator 2.

Therefore the first user/the session creator 2 have full control of the private data. This is ensured by making all communication first go through for example a browser of the session creator 2. The cobrowse server 4 is no longer in between the original web server 5 and the participants 3 compared with conventional systems. The cobrowse server 4 is only between the session creator 2 and the other participants 3 whereas the session creator 2 has direct connections with the origin web server 5.

Further private data can be masked by the session creator 2, so that other participants 3 can still cobrowse together but without disclosing private data.

Even further cobrowsing is enabled for both HTTP-based non-secure web services and HTTPS-based secure web services, because the cobrowse server 4 is only between the session creator 2 and the participants 3 and not compared with conventional systems in between the origin web server 5 and the session creator 2. Therefore there is no need to break HTTPS connections in between them.

FIG. 3 shows a part of a method and a system according to a second embodiment of the present invention.

In FIG. 3 a basic work flow of a privacy preserving cobrowsing service is shown.

In FIG. 3 a system according to FIG. 2 is shown in more detail. The origin web server 5 comprises a rule specificator for specifying private data. Further a cobrowse button is embedded into data responses, for example webpages. The cobrowse button may be provided in form of JavaScript code files given by the cobrowsing service provider to provide functionalities of privacy preserving cobrowsing service and could be reviewed by others to check whether they are doing what they are supported to do for the purpose of accountability.

In FIG. 3 two JavaScript code files to enable privacy preserving cobrowsing, controller.js and participants.js are used. The JavaScript code files are used by the session creator 2 by executing them. The cobrowse server 4 comprises an event coordinator for event synchronization between the session creator 2 and the other participants 3. The participants 3 execute the JavaScript code file participant.js. The JavaScript code file participant.js is used by all users, i.e. the participants and the session creator, in the same cobrowsing session for synchronizing user interactions on the shared webpages.

In a first step S1 the first user respectively the session creator 2 fetches a cobrowsed webpage comprising a cobrowse button and the JavaScript codes participant.js and controller.js will be triggered to start privacy preserving cobrowsing service when the session creator 2 clicks on the cobrowse button.

Preferably the JavaScript code file controller.js will fetch in a second step S2 the rules/specification defined by the provider from the origin web server 5 and apply them into the current requested webpage, so that the first user can visually see which part of elements in the current webpage are initially masked as private by the web service provider of the origin web server 5.

In a third step S3 the first user respectively the session creator 2 can mask further elements which might contain some private data from his prospective or might remove predefined masked elements.

In a fourth step S4 via a first channel C1 after the first user respectively the session creator 2 finishes masking private elements on the current web page and confirms to start a cobrowsing session with the other participants 3, the session creator 2 will contact the cobrowse server 4 and get for example a unique session ID for the current web page in return. Contacting the cobrowse server 4 by the session creator 2 via the first channel C1 requires cross-origin communication supported in particular by most standard browsers.

In a fifth step S5 the session creator 2 generates a key for data exchanging among all participants 3 in the current cobrowsing session, uses the session ID and the generated key to construct a session URL and then spreads the generated session URL to other participants 3 through a second communication channel C2.

The second communication channel C2 may be for example provided by a social network, a mail service or some service provided by the origin web server 5 and different from the first communication channel C1.

In a sixth step S6 the other participants 3 get the session URL and start to join the masked cobrowse webpage through the cobrowse server 4 after clicking the session URL.

In a seventh step S7 the cobrowse server 4 asks for the masked webpage from the session creator 2 and transmits the masked webpage to the other participants 3 upon receiving the joining request from the other participants 3. The JavaScript module participant.js is injected into the masked webpage for event synchronization between the first user respectively the session creator 2 and the other participants 3. Additionally to prevent the cobrowse server 4 or any intermediate attackers from seeing the masked webpage, the session creator 2 can encrypt the masked webpage with the generated key before sending the masked webpage out. Therefore only participants 3 who have the generated key can see the masked webpage.

In an eighth step S8 the other participants 3 receive the masked webpage and may also request the external objects embedded in the received webpage from the cobrowse server 4 like static images, CSS files or the like. These external objects may be forwarded by the cobrowse server 4 from the session creator 2 to the other participants 3. If the session creator 2 cannot fetch these requested external objects from its local cache the session creator 2 will refetch them from the origin web server 5 and transmit them to the cobrowse server 4 for forwarding them to the participants 3.

In a ninth step S9 the first user respectively the session creator 2 and the other participants 3 now start to interact with the current web page for experience sharing or collaboration. The interactions will be synchronized by the injected JavaScript module participant.js and coordinated by the event coordinator in the cobrowse server 4 under consideration of their slightly different webpages.

In other words the first user respectively the session creator 2 is used as a proxy to control which part of a requested page or application to share with others in the same cobrowsing session. The first user first fetches the content and has full control of which part of content to show to the other participants 3 in the cobrowsing session. The first user keeps a full control of his/her private data within the cobrowsed webpage and the session creator acts as a special type of proxy for all the other participants 3. All requests issued by the other participants 3 will go through the session creator 2 and via the cobrowse server 4.

Marking private elements can be performed by the first user 2 who creates the co-browsing session. For example the first user may specify private data on its browser by choosing which part of content to hide before the other participants join the cobrowsing session. The second option is to mark data as private elements by the origin web server 5. For example the owner of the origin web server 5 can use an external file associated with the cobrowsed page to specify which elements in the page are private or which additional property elements must have to be marked as private elements in the page.

Before the first user fetches the webpage for starting a cobrowsing session the origin web service provider can mark the webpage to specify which part of the page is supposed to be sensitive for their customers. This part of content can be automatically regarded as private element when some users establish a cobrowsing session for that page. An external file associated with the page can be created by a web service provider to define the private elements in the page for example through a declarative script language which can be interpreted by the session creator 2. Further, the first user may mark private data before the webpage is transmitted to other participants 3. The first user may visually see which parts of elements are already marked and can also continue to mark some other elements in a visualized way.

To improve user experience global policies as part of a requested document, for example a HTML-document may be defined, so that for example they do not propagate form data or do not show text in tables or using a HTML query language for defining what should be replaced, for example webQuery. Using such a language enables more flexibility. To check the masked private data a test mode for the first user respectively the session creator 2 can be provided. The first user can then see what information the other participants 3 can actually see to make sure that the private data have been correctly masked. For example this can be provided that upon a click on a bottom or a special key on a keyboard or any other input the user can switch between a masked and a non-masked version of the requested webpage.

A template can be provided to the users to reuse some pre-defined masking rules, i.e. the rules/specifications which elements are considered as private data and will be masked. Also different parts, for example of a HTML-document, can be marked as private for different participants, so that each participant can see his/her individual view on private data allowing an individualization for each participant corresponding to an assigned “security level” for each participant.

To execute hiding the private data associated with the masked private elements is modified and for example replaced with some non-sense data according to the type of the private elements. In the table below examples for rules for this masking are shown. These rules ensure that private data is masked but still allow synchronization of a multiuser web session:

| Rule | Description | Example | Output |
|---|---|---|---|
| Mask any text | This rule | <span itemprop=”private”> | <span itemprop=”private”> |
| | converts | private data<table | XXXXXXXXXXXX<table |
| | each text | class=”mytemplate”><tr><td>First | class=”mytemplate”><tr><td>X |
| | character | Head</td><td>Second | XXXXXXXXX</td><td>XXXXX |
| | into “X”, but | Head</td></tr></table> </span> | XXXXXX</td></tr></table> |
| | ignoring | | </span> |
| | HTML Tags | | |
| Mask input | This rule | <span itemprop=”private”><input | <span |
| Values | masks text | value=”myprivateinput”></input> | itemprop=”private”><input |
| | in input | </span> | value=”XXXXXXXXXXXXXX”> |
| | fields | | </input> |
| | | | </span> |
| Mask select | This rule | <span itemprop=”private”> | <span itemprop=”private”> |
| values | masks text | <select | <select |
| | in lists (e.g. | id=”myprivateoptions”><option | id=”myprivateoptions”><option |
| | dropdown | value=”myoption1”>Option | value=”XXXXXXXXX”>XXXXX |
| | lists) | 1</option> | XXX</option> |
| | | <option | <option |
| | | value=”myoption2”>Option | value=”XXXXXXXXX”>XXXXX |
| | | 2</option> | XXX</option> |
| | | </select> | </select> |
| | | </span> | </span> |
| Mask | This rule | <span itemprop=”private”> | The image img.png will be |
| images/videos | masks | <img src=”img.png” /></span> | replaced by a transparent |
| | images | | image or an image with a |
| | | | privacy note of the same |
| | | | dimension as the original |
| | | | image. |

Of course further rules can be added masking data or attributes of other tags, preferably similar as described in the table above.

To avoid that other parties cannot see—additionally to the masked private data—other web application data, HTTPS-based connections between all communicating entities or components may be used. HTTPS-based connections can easily be implemented since for example—in all modern browsers HTTPS is supported.

Another option is to use an asymmetric cryptographic method, for example public key/private key encryption together with an external party acting as a certification authority. This makes sure that each participant in the multiuser web session is the one he/she pretends to be and that only these participants can en-/decrypt exchanged data. This allows for example that the cobrowse server 4 cannot see any web application data exchange between the participants 3 of the multiuser web session.

The cobrowse server 4 comprises also—as mentioned above—an event coordinator operable to synchronize user interactions over the shared webpage with masked private data, so that the first user/session creator 2 and the other participants 3 are able to share their activities on the browsed webpage for example without disclosing the masked private data to the other participants 3. The event coordinator is in particular operable to coordinate the needs of the participants 3 to work on slightly different webpages: For example the event coordinator in the cobrowse server 4 avoids the propagation of the update events associated with the private data of those marked private elements.

In summary the present invention enables the first user/session creator 2 to keep control which part of content of a page in a multiuser web session to share with other participants in the same session. The present invention further enables the web server 5 as well as the first user/session creator 2 to be able to mark private elements within a cobrowsed webpage. Even further the present invention enables an element-adaptive obfuscating method to hide private data associated with each private element before for example a cobrowsed page being sent out from the first user/session creator 2 to the other participants 3. The first user therefore prevents both the cobrowse server 4 and the other participants 3 from seeing her/his private data.

The present invention has inter alia the following advantages: Private data is hidden from third parties in a multiuser web session. Both normal pages like webpages and secure pages are supported architecturally for browsing in a multiuser web session. Further cobrowsing for HTTPS-based web services is also supported.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for providing a multiuser web session, preferably a collaborative web browsing session like a cobrowsing session, comprising the steps of
a) Establishing a multiuser web session with different participants (2, 3),
b) Providing the multiuser web session via a session server (4) to the different participants (2, 3),
c) Relaying requests from the participants (2, 3) to one or more web servers (5) and responses from the one or more web servers (5) to the participants (2, 3),
characterized in that
a participant (2) of the multiuser web session creates the multiuser web session, establishes a connection, preferably a secure connection, with the one or more web servers (5) and relays the outside multiuser web communication (20) between all the participants (2, 3) of the multiuser web session and the one or more web servers (5), wherein private data is masked.

2. The method according to claim 1, characterized in that the participant (2) creating the multiuser web session masks private data.

3. The method according to claim 1, characterized in that the one or web servers (5) mark elements indicating private data in the responses.

4. The method according to claim 1, characterized in that private data is marked visually.

5. The method according to claim 1, characterized in that a marking policy is generated for automatically masking private data.

6. The method according to claim 1, characterized in that prior to provide data including masked private data to the other participants (3) a preview of the data is performed, preferably by the participant (2) which created the multiuser web session.

7. The method according to claim 5, characterized in that the marking policy is stored for later use.

8. The method according to claim 1, characterized in that for each participant (2, 3) individual marking of private data is performed.

9. The method according to claim 1, characterized in that masking of private data is performed by replacing the private data with predefined non-sensible data.

10. The method according to claim 9, characterized in that the predefined non-sensible data, preferably in form of random data, is based on the type and/or element type of the private data.

11. The method according to claim 1, characterized in that a secure connection (20; 10, 11) is used between the participants (2, 3) and/or between the participant (2) creating the multiuser web session and the one or more web servers (5).

12. The method according to claim 1, characterized in that the secure connection is provided in form of a HTTPS connection or a public key/private key encrypted connection.

13. The method according to claim 1, characterized in that events on masked private data are coordinated, preferably via the session server (4), to synchronize actions of participants (2, 3) on private data among the other participants (2, 3).

14. The method according to claim 1, characterized in that multiuser web session information ensuring privacy of private data is provided by the one or more web servers (5) applied in the multiuser web session, preferably by executing the multiuser web session information by the participant (2) creating the multiuser web session.

15. A system for providing a multiuser web session, preferably a collaborative web browsing session like a cobrowsing session, and preferably for performing with a method according to claim 1, comprising one or more web servers for providing content, a session server (4) for relaying communication between participants (2, 3) of the multiuser web session and user participating means for participating in the multiuser web session by users,
characterized in that
at least one of the participating means is operable to create the multiuser web session, to establish a connection, preferably a secure connection (20), with the one or more web servers (5), to relay the outside multiuser web communication (20) between all the participants (2, 3) of the multiuser web session and the one or more web servers (5), and to mask private data.
